(19) United States
(12) Patent Application Publication
(10) Pub. No.: US 2025/0265680 A1
(43) Pub. Date: Aug. 21, 2025

(54) ELECTRONIC DEVICE, OPERATION METHOD, AND STORAGE MEDIUM FOR ANALYZING AND IMPROVING IMAGE QUALITY OF TRANSPARENT BACKGROUND IMAGE

(71) Applicant: Samsung Electronics Co., Ltd., Suwon-si (KR)

(72) Inventors: Kyuwon KIM, Suwon-si (KR); Jongkyu KIM, Suwon-si (KR); Hyunsoo KIM, Suwon-si (KR); Chulju YANG, Suwon-si (KR); Heekuk LEE, Suwon-si (KR); Inho CHOI, Suwon-si (KR)

(21) Appl. No.: 19/193,192

(22) Filed: Apr. 29, 2025

Related U.S. Application Data
(63) Continuation of application No. PCT/KR2023/017491, filed on Nov. 3, 2023.

(30) Foreign Application Priority Data
Nov. 4, 2022 (KR) 10-2022-0145718
Dec. 7, 2022 (KR) 10-2022-0169447

(51) Int. Cl. G06T 5/50; G06T 7/13; G06T 7/73; G06T 11/00

(52) U.S. Cl. CPC G06T 5/50; G06T 7/13; G06T 7/73; G06T 11/001; G06T 2210/62

(57) ABSTRACT

An electronic device is provided. The electronic device includes memory storing one or more computer programs, and one or more processors communicatively coupled to the memory, wherein the one or more computer programs include computer-executable instructions that, when executed by the one or more processors individually or collectively, cause the electronic device to receive a user input related to image quality of a first image, determine whether a transparent region exists in the first image, determine a plurality of transparent pixels corresponding to the transparent region when the transparent region exists in the first image, extract contour pixels adjacent to a pixel corresponding to an object included in the first image among the plurality of transparent pixels, change color information about each pixel included in a first set of contour pixels among the extracted contour pixels based on color information about pixels adjacent to each pixel, generate a second image including the contour pixels of the changed color information, and apply an image quality enhancement algorithm to the second image.

### CROSS-REFERENCE TO RELATED APPLICATION(S)

This application is a continuation application, claiming priority under 35 U.S.C. § 365 (c), of an International application No. PCT/KR2023/017491, filed on Nov. 3, 2023, which is based on and claims the benefit of a Korean patent application number 10-2022-0145718, filed on Nov. 4, 2022, in the Korean Intellectual Property Office, and of a Korean patent application number 10-2022-0169447, filed on Dec. 7, 2022, in the Korean Intellectual Property Office, the disclosure of each of which is incorporated by reference herein in its entirety.

### BACKGROUND

### 1. Field

The disclosure relates to an electronic device, an operation method, and a storage medium for analyzing and improving the image quality of a transparent background image.

### 2. Description of Related Art

An electronic device may extract an object from an image and generate and transmit a remaining transparent background image excluding the object. The electronic device may use object segmentation technology and image matting technology to generate a transparent background image. Object segmentation technology is a technology that separates object regions within an image at the pixel level of the image. Image matting technology is a technique that extracts only a foreground from a background and foreground included in an image.

In addition, the electronic device may identify and enhance the image quality using an image quality enhancement algorithm based on a convolutional neural network (CNN).

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device, an operation method, and a storage medium for analyzing and improving the image quality of a transparent background image.

Additional aspects will be set forth in part in the description which follows and, in part, will be apparent from the description, or may be learned by practice of the presented embodiments.

In accordance with an aspect of the disclosure, an electronic device is provided. The electronic device includes memory storing one or more computer programs, and one or more processors communicatively coupled to the memory, wherein the one or more computer programs include computer-executable instructions that, when executed by the one or more processors individually or collectively, cause the electronic device to receive a user input related to image quality of a first image, determine whether a transparent region exists in the first image, determine a plurality of transparent pixels corresponding to the transparent region when the transparent region exists in the first image, extract contour pixels adjacent to a pixel corresponding to an object included in the first image among the plurality of transparent pixels, change color information about each pixel included in a first set of contour pixels among the extracted contour pixels based on color information about pixels adjacent to each pixel, generate a second image including the contour pixels of the changed color information, and apply an image quality enhancement algorithm to the second image.

In accordance with another aspect of the disclosure, a method performed by an electronic device is provided. The method includes receiving, by the electronic device, a user input related to image quality of a first image, determining, by the electronic device, whether a transparent region exists in the first image, determining, by the electronic device, a plurality of transparent pixels corresponding to the transparent region based on determining that the transparent region exists in the first image, extracting, by the electronic device, contour pixels adjacent to a pixel corresponding to an object included in the first image among the plurality of transparent pixels, changing, by the electronic device, color information about each pixel included in a first set of contour pixels among the extracted contour pixels based on color information about pixels adjacent to each pixel, generating, by the electronic device, a second image including the contour pixels of the changed color information, and applying, by the electronic device, an image quality enhancement algorithm to the second image.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations include receiving, by the electronic device, a user input related to image quality of a first image, determining, by the electronic device, whether a transparent region exists in the first image, determining, by the electronic device, a plurality of transparent pixels corresponding to the transparent region based on determining that the transparent region exists in the first image, extracting, by the electronic device, contour pixels adjacent to a pixel corresponding to an object included in the first image among the plurality of transparent pixels, changing, by the electronic device, color information about each pixel included in a first set of contour pixels among the extracted contour pixels based on color information about pixels adjacent to each pixel, generating, by the electronic device, a second image including the contour pixels of the changed color information, and applying, by the electronic device, an image quality enhancement algorithm to the second image.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating a configuration of an electronic device according to an embodiment of the disclosure;

FIG. 2 is a functional block diagram of an electronic device according to an embodiment of the disclosure;

FIG. 3 is a flowchart of operations of an electronic device according to an embodiment of the disclosure;

FIG. 4 is a view illustrating an example of adjacent pixels determined by an electronic device according to an embodiment of the disclosure;

FIG. 5 is a view for describing an operation in which an electronic device according to an example adds a layer of contour pixels according to an embodiment of the disclosure;

FIG. 6 is a flowchart of operations of an electronic device according to an embodiment of the disclosure;

FIG. 7 is a view illustrating an example of image quality analysis information provided by an electronic device according to an embodiment of the disclosure;

FIG. 8 is a view for describing a method for determining the number of layers of an electronic device according to an embodiment of the disclosure;

FIG. 9 is a view illustrating an image of enhanced image quality of an electronic device according to an example, in a manner of comparing with an original image and an image of enhanced image quality of an electronic device according to an embodiment of the disclosure;

FIG. 10 is a flowchart of operations of an electronic device according to an embodiment of the disclosure; and

FIG. 11 is a block diagram of an electronic device in a network environment according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi™ chip, a Bluetooth™ chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

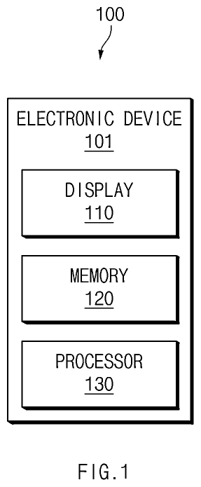

FIG. 1 is a block diagram illustrating a configuration of an electronic device according to an embodiment of the disclosure.

Referring to FIG. 1, block diagram 100 illustrates that an electronic device 101 according to an example may include a display 110, memory 120, and/or a processor 130. For example, the electronic device 101 may further include other components (e.g., a camera or communication circuitry) not illustrated in FIG. 1.

The display 110 may visually provide information to a user. For example, the display may provide a graphical user interface (GUI). For example, the graphical user interface may include a user interface (UI) related to improving image quality.

The memory 120 may store one or more instructions for operating the electronic device 101. The memory 120 may store data or information necessary for the operation of the electronic device 101. For example, the memory 120 may store at least one image. At least one image may be, for example, an image captured using a camera of the electronic device 101 or an image received through a communication circuit of the electronic device 101.

For example, the memory 120 may store at least one image quality enhancement algorithm. The image quality enhancement algorithm (or image quality enhancement model) may be, for example, a convolutional neural network (CNN)-based algorithm. The image quality enhancement algorithm may include at least one of a super resolution (or upscaling) algorithm, a deblur algorithm, a denoise algorithm, an exposure correction algorithm, a low-light enhancement algorithm, a compression artifact removal algorithm, or a haze removal algorithm. The input image of the CNN-based image quality enhancement algorithm may be a three-channel image including a red channel, a green channel, and a blue channel. For example, in a four-channel transparent background image including red green blue (RGB) channels and an alpha channel, only the RGB channels, excluding the alpha channel, may be input to the CNN-based image quality enhancement algorithm.

The processor 130 may be operatively connected to the display 110 and the memory 120. Operationally connected between components may mean that the components are functionally connected or communicatively connected. For example, operationally connected components may exchange data with each other. The processor 130 may execute one or more instructions stored in the memory 120.

The processor 130 may receive a user input related to the image quality of the image. The processor 130 may receive a user input for selecting an image. For example, the processor 130 may receive a user input for selecting an image whose image quality is to be enhanced among at least one image stored in the electronic device 101 (or a gallery application of the electronic device 101). The processor 130 may receive an image quality enhancement request for the selected image. For example, after receiving the user input for selecting an image, the processor 130 may receive the user input related to image quality for the selected image. The user input related to image quality may include, for example, a user input for selecting an item for performing image quality enhancement from a menu item of a provided user interface.

The processor 130 may determine whether there is a transparent region in the selected image. For example, the processor 130 may separate the RGB channels and alpha channel of the selected image. The alpha channel is a channel that stores data other than the RGB values stored in the RGB channels for each pixel, and may store transparency information, for example. The processor 130 may identify whether there is a transparent region in the image based on transparency information stored in the alpha channel of the image.

As another method for identifying the presence of a transparent region, the processor 130 may determine whether there is a transparent region in an image based on transparency information contained in a specified field of a header of an image file (e.g., a field indicating a background color).

The processor 130 may apply the specified image quality enhancement algorithm to the image when the transparency information stored in the alpha channel of the pixels constituting the image indicates that all are opaque. The specified image quality enhancement algorithm may include, for example, an image quality enhancement algorithm for a normal image rather than a transparent background image. The processor 130 may set color information (e.g., RGB values) about at least some of the pixels corresponding to the transparent region of the image when at least some of the transparency information stored in the alpha channel of the pixels constituting the image indicate transparency. In the disclosure, an operation of setting color information may be referred to as a painting operation or a coloring operation.

The processor 130 may set color information about each pixel based on color information about pixels adjacent to each pixel corresponding to the transparent region. For example, the processor 130 may extract color information about the pixels adjacent to each pixel corresponding to the transparent region. For example, an image with the alpha channel may have either a format where the RGB values are multiplied by the alpha value normalized between 0 and 1, e.g., a premultiplied alpha format, or a format where there is the alpha value separately from the RGB values, e.g., a non-premultiplied alpha format.

The processor 130 may extract color information about desired pixels (e.g., pixels adjacent to each pixel corresponding to the transparent region) after performing unpremultiplying when an original image is an image in the premultiplied alpha format. The unpremultiplying may be, for example, an operation of dividing the RGB value multiplied by the alpha value by the alpha value. The processor 130 may extract color information about a desired pixel without additional operations such as unpremultiplying when the original image is an image in the non-premultiplied alpha format. For example, since graphics interchange format (GIF) images do not have translucent images, but only transparent or opaque images, GIF images may be non-premultiplied alpha format images. For example, since portable network graphics (PNG) images have translucent images in addition to transparent or translucent images, the PNG images may be images in either premultiplied alpha format or non-premultiplied alpha format. Depending on the operating system that the processor 130 runs, a determination as to whether the image is in the premultiplied alpha format or non-premultiplied format may be made.

The processor 130 may set color information about at least some of a plurality of transparent pixels corresponding to the transparent region when there is the transparent region in the image. For example, the processor 130 may extract contour pixels adjacent to a pixel corresponding to an object included in the image among the plurality of transparent pixels corresponding to a transparent region. For example, the processor 130 may generate a set of extracted contour pixels. In the disclosure, the processor 130 generating the set of contour pixels may be referred to as the processor 130 defining the extracted contour pixels as the same group. In the disclosure, the set of contour pixels may be referred to as a contour.

The processor 130 may set color information about a pixel (e.g., a contour pixel) included in the set of contour pixels based on color information about pixels adjacent to each pixel. For example, pixels adjacent to the contour pixel may contain a specified number of pixels (e.g., 4, 8, or 12) surrounding the contour pixel. The processor 130 may extract color information about the specified number of pixels surrounding the contour pixel and obtain an average value or a median value of at least one significant color (e.g., a non-transparent color) among them. The processor 130 may change the color information about the contour pixel to the obtained average value or median value.

A set of contour pixels having changed color information may form a layer surrounding the object. For example, the processor 130 may extend the contour by forming a plurality of layers. The processor 130 may generate an RGB image including an object and at least one layer surrounding the object, and use the generated RGB image as an input image of the CNN-based image quality enhancement algorithm. The processor 130 may generate a specified number of sets (or layers) of contour pixels and set color information about pixels included in each set (or layer). A specified number of sets of contour pixels may be referred to as a specified number of layers.

For example, the processor 130 may generate a first set of contour pixels by extracting contour pixels adjacent to a pixel corresponding to an object. For example, the processor 130 may extract contour pixels adjacent to a pixel corresponding to an object and define the extracted contour pixels as a first set. The processor 130 may set color information about each pixel included in the first set based on color information about pixels adjacent to each pixel. Pixels adjacent to each pixel included in the first set may include, for example, pixels corresponding to an outer edge of the object. The processor 130 may set color information about the contour pixels of the first set based on color information about pixels corresponding to the outer edge of the object neighboring each pixel.

For example, the processor 130 may identify the locations of pixels in the transparent region adjacent to the contour pixels of the first set. The processor 130 may extract pixels whose locations are identified to generate a second set of contour pixels. For example, the processor 130 may extract pixels whose locations have been identified based on the contour pixels of the first set and define the extracted pixels as the second set. The processor 130 may set color information about each pixel included in the second set based on color information about pixels adjacent to each pixel. Pixels adjacent to each pixel included in the second set may include, for example, pixels corresponding to the outer edge of the object and/or the contour pixels of the first set. The processor 130 may set color information about contour pixels of the second set based on color information about pixels corresponding to the outer edge of the object neighboring each pixel and/or color information about the contour pixels of the first set neighboring each pixel.

For example, the processor 130 may repeat the operation of setting color information about the extracted contour pixels, identifying the locations of pixels of the transparent region adjacent to the contour pixels, and extracting contour pixels of the identified locations as many times as the specified number of sets of contour pixels. When setting color information about pixels included in the most recently generated set, the processor 130 may omit an operation of identifying locations of pixels of a transparent region adjacent to the pixels included in the most recently generated set.

The processor 130 may generate an image in which color information is changed for the contour pixels. For example, the processor 130 may generate an image in which color information is changed for contour pixels included in a set of a specified number of contour pixels. An image in which color information is changed for contour pixels may be referred to as an image in which RGB color settings for contour pixels are completed or an image for which coloring of contour pixels is completed.

For example, the processor 130 may set color information about all pixels corresponding to the transparent region using the method for setting color information to the contour pixels described above. In this case, the accuracy during image quality analysis for the image in which color information settings are completed or the degree of image quality enhancement for the image in which color information settings are completed is improved the most, but the amount of computation of the processor 130 may be excessive.

For example, the processor 130 may obtain an average value by averaging the color information about the pixels included in the set of contour pixels most recently generated by the method for setting color information to the contour pixels described above, and set color information about pixels corresponding to a remaining transparent region of the original image with the obtained average value. In this case, the degree to which the accuracy or image quality enhancement during image quality analysis is improved may be reduced compared to the aforementioned method for coloring the entire transparent region, but the amount of computation of the processor 130 may also be reduced.

For example, the processor 130 may set the color information about all the pixels corresponding to the transparent region to a value representing gray. Gray may be any value between the lightest white and the darkest black. In this case, the degree to which the accuracy or image quality enhancement during image quality analysis is improved may be further reduced compared to the method for coloring the remaining transparent region with the average value of pixels included in the set of contour pixels most recently generated, but the amount of computation of the processor 130 may also be further reduced. For example, when the processor 130 uses the method for setting the entire transparent region to gray, the amount of computation of the processor 130 may be reduced the most.

The processor 130 may appropriately select one of the above-described methods based on the resolution of the image or the specifications of the electronic device. For example, in the case of a high-resolution image (e.g., an image of a threshold resolution or more) or a low-spec terminal such as a wearable device (e.g., a specified low-spec terminal), a method that may relatively reduce the amount of computation of the processor 130 may be selected (e.g., the method for coloring the remaining transparent region with the average value of pixels included in the set of contour pixels generated most recently, or the method for setting the entire transparent region to gray).

The processor 130 may perform image quality analysis on the image in which RGB color settings for the pixels corresponding to the transparent region or contour pixels are completed. For example, an image used for image quality analysis may be an image in which RGB colors of the pixels corresponding to the transparent region or contour pixels are set for at least a partial region of the original image.

The processor 130 may analyze the image (e.g., image quality analysis) and determine an image quality enhancement algorithm corresponding to the image. For example, the processor 130 may determine at least one of image quality enhancement algorithms stored in the memory 120 based on analysis results for the image. The image quality enhancement algorithms stored in the memory 120 may be, for example, a CNN-based algorithm, and may include a super resolution (or upscaling) algorithm, a deblur algorithm, a denoise algorithm, an exposure correction algorithm, a low-light enhancement algorithm, a compression artifact removal algorithm, and/or a haze removal algorithm.

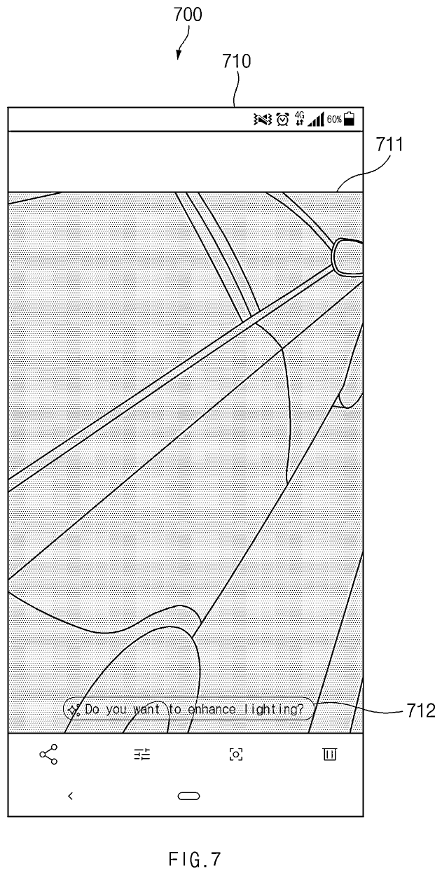

For example, the processor 130 may display information recommending the determined image quality enhancement algorithm on the display 110. In this regard, a more detailed embodiment is described with reference to FIG. 7.

For example, when the RGB color of pixels corresponding to a transparent region of an image is set to black, the transparent region may be recognized as a dark region. In this case, when analyzing the image quality for the image, the image may be misrecognized as a low-light image or an image that has been affected by exposure during image capturing. The processor 130 may extract contour pixels from pixels corresponding to a transparent region of the image and set the RGB color of the contour pixels based on RGB color information about non-transparent pixels adjacent to each pixel, thereby reducing the possibility of misrecognition during image quality analysis and reducing the possibility of recommending an inappropriate image quality enhancement algorithm.

The processor 130 may identify the number of sets (or layers) of contour pixels required by the determined image quality enhancement algorithm. For example, the number of layers may be determined by the size of a kernel for performing a convolution operation of an image quality enhancement algorithm (or image quality enhancer) to be applied. The kernel is a weight parameter of a convolutional layer, and the kernel may be applied to input data in the convolutional layer to output a feature map, and the feature map may be passed to the next layer. For example, the larger the size of the kernel, the more layers may be used. For example, when the maximum size of the kernel is k, the number of layers may be (k−1)/2.

The processor 130 may perform image quality enhancement by generating the identified number of sets of contour pixels and applying the determined image quality enhancement algorithm to an image in which color information about pixels included in each set is set. The image to which an image quality enhancement algorithm is applied may be an image in which the RGB colors of the contour pixels are set for the entire region of the original image.

The processor 130 may perform coloring on only at least some of the sets of contour pixels based on the resolution of the original image or the specifications of the electronic device 101. For example, the processor 130 may set color information about contour pixels included in at least some of the sets to a value representing gray based on the resolution of the original image or the specifications of the electronic device 101. For example, when the resolution of the original image is equal to or higher than a specified value or when the electronic device 101 corresponds to a specified low-spec terminal such as a wearable device, the color information about the contour pixels included in at least some of the sets may be set to a value representing gray. The processor 130 may perform coloring on only some of the determined number of layers and set remaining layers to a value representing gray, thereby reducing the amount of computation and increasing the computation speed.

The processor 130 may obtain an image of enhanced image quality by performing image quality enhancement on the image in which RGB color settings of the contour pixels are completed. The processor 130 may set the RGB values of the contour pixels in the image of enhanced image quality to “0.” Accordingly, unnecessary pieces of color information added to the contour pixels may be deleted.

The processor 130 may adjust the size of the alpha channel of the original image to correspond to the RGB channels of the image of enhanced image quality. For example, the processor 130 may adjust the resolution of the alpha channel of the original image to be the same as the resolution output from the image quality enhancement algorithm. For example, when the used image quality enhancement algorithm is the super resolution algorithm that upscales by four times in width and four times in height, the processor 130 may also upscale the alpha channel by four times in width and four times in height.

For example, the processor 130 may set the RGB value of a pixel in which the value of the alpha channel whose size is adjusted is “0” (fully transparent) to “0.” Accordingly, unnecessary pieces of color information added to the contour pixels may be deleted.

The processor 130 may generate a resulting image of enhanced image quality by merging the RGB channels of the image of enhanced image quality and the alpha channel whose size is adjusted. For example, the processor 130 may generate a red, green, blue, alpha (RGBA) channel by adding the alpha channel to the RGB channels after setting the RGB values of the contour pixels to “0” for the image of enhanced image quality.

For example, when the original image is in the premultiplied alpha format, the processor 130 may perform premultiplication (or premultiplication operation) on the RGBA channel of the resulting image.

The processor 130 may configure the resulting image in RGBA or bitmap format. The processor 130 may convert the resulting image into the RGBA or bitmap format that matches the alpha format of the original image.

The processor 130 may compare and display the original image and the resulting image. The processor 130 may display the original image and the resulting image on the display 110. For example, the processor 130 may display the original image and the resulting image on the display 110 simultaneously or sequentially. For example, the processor 130 may alternately display the original image and the resulting image on the display 110.

For example, when the RGB colors of the pixels corresponding to the transparent region of the image are set to black, black artifacts may be present in a contour region of the object in the image after image quality enhancement. For another example, when the RGB colors of pixels corresponding to the transparent region of the image are randomly set, artifacts of various colors may be present in the contour region of the object in the image after image quality enhancement. The processor 130 may extract contour pixels from the pixels corresponding to the transparent region of an image and set RGB colors of the contour pixels based on RGB color information about non-transparent pixels adjacent to each pixel, thereby reducing artifacts that may appear in the contour region of the object in the image after image quality enhancement. Accordingly, the processor 130 may clearly display the transparent background image of enhanced image quality on the background of various colors without contour artifacts.

The processor 130 may receive a user input requesting storage of the resulting image. The processor 130 may, in response to the user input requesting storage of the resulting image, convert the resulting image into a specified file format and store it. For example, the specified file format may include a file format that is the same as the file format of the original image (e.g., PNG or GIF) or a new file format (e.g., WebP).

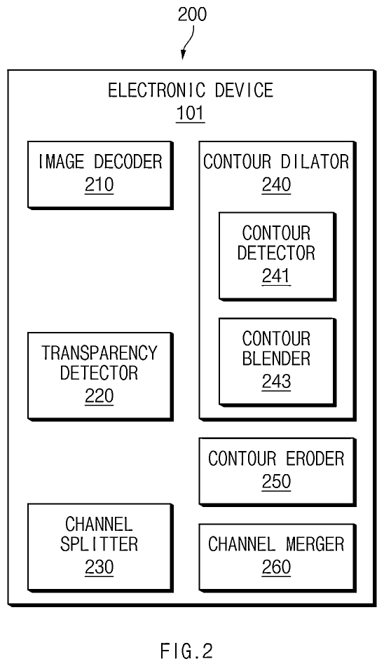

FIG. 2 is a functional block diagram of an electronic device according to an embodiment of the disclosure. The electronic device described below may be, for example, the electronic device 101 in FIG. 1.

Referring to FIG. 2, block diagram 200 illustrates that an electronic device 101 may include an image decoder 210, a transparency detector 220, a channel splitter 230, a contour dilator 240, a contour eroder 250, and/or a channel merger 260. The image decoder 210, the transparency detector 220, the channel splitter 230, the contour dilator 240, the contour eroder 250, and/or the channel merger 260 may be software modules. Each module may be a set of instructions to implement each function. The operations of each module to be described below may be performed by at least a hardware component (e.g., the processor 130) of the electronic device 101 illustrated in FIG. 1.

The image decoder 210 may be, for example, a part of a CNN-based image quality enhancement model for an image. For example, the image decoder 210 may include a plurality of image decoders corresponding to a plurality of image quality enhancement algorithms. The image decoder 210 may obtain an image of enhanced image quality by applying a corresponding image quality enhancement algorithm.

The transparency detector 220 may determine whether there is a transparent region in an image. For example, the transparency detector 220 may determine whether there is an alpha channel in the image. For example, the transparency detector 220 may identify, when there is the alpha channel in the image, whether there is a pixel whose alpha channel value is not 0xFF (e.g., a pixel whose alpha channel value is 0x00).

As another method for identifying the presence of a transparent region, the transparency detector 220 may determine whether there is the transparent region in the image based on transparency information contained in a specified field of a header of an image file (e.g., a field indicating a background color).

The channel splitter 230 may separate the RGB channels and alpha channel of the image. The above-described transparency detector 220 may determine whether there is the transparent region in the image based on the alpha channel separated by the channel splitter 230.

For example, for a multi-frame image, the transparency detector 220 may determine whether there is the transparent region in the image by examining only the alpha channel of a first frame.

The contour dilator 240 may dilate a contour between an object and the transparent region within the image. Dilating of the contour may be referred to as setting the color information (e.g., RGB values) about contour pixels adjacent to the object among the pixels corresponding to the transparent region to a meaningful value. For example, the contour dilator 240 may include a contour detector 241 and a contour blender 243.

The contour detector 241 may detect a contour between an object and a transparent region within an image. For example, the contour detector 241 may extract contour pixels adjacent to the object among pixels corresponding to the transparent region.

The contour blender 243 may fill a contour color by extracting valid (or meaningful) color information around the contour. For example, the contour blender 243 may set color information about the contour pixels based on color information about pixels adjacent to each contour pixel.

For example, the contour detector 241 may extract contour pixels adjacent to a pixel corresponding to the object among pixels corresponding to the transparent region. For example, the contour detector 241 may generate a first set of contour pixels by defining the extracted contour pixels as the first set of contour pixels. The contour blender 243 may change color information about each pixel included in the first set based on color information about pixels adjacent to each pixel. The contour detector 241 may identify locations of the pixels in the transparent region adjacent to the contour pixels of the first set whose color information has been changed. The contour detector 241 may extract pixels at the identified locations. For example, the contour detector 241 may generate a second set of contour pixels by defining the extracted pixels as the second set of contour pixels. The contour blender 243 may set color information about each pixel included in the second set based on color information about pixels adjacent to each pixel. The contour detector 241 and the contour blender 243 may dilate the contour by repeating this process.

The contour eroder 250 may delete the contour dilated by the contour dilator 240. For example, the contour eroder 250 may delete color information about contour pixels set by the contour dilator 240. Deleting color information about contour pixels may include, for example, setting the RGB values of the contour pixels to “0.”

The channel merger 260 may combine the alpha channel and RGB channels and express them as an RGBA channel. For example, the channel merger 260 may merge the RGB channel and the alpha channel to generate the RGBA channel.

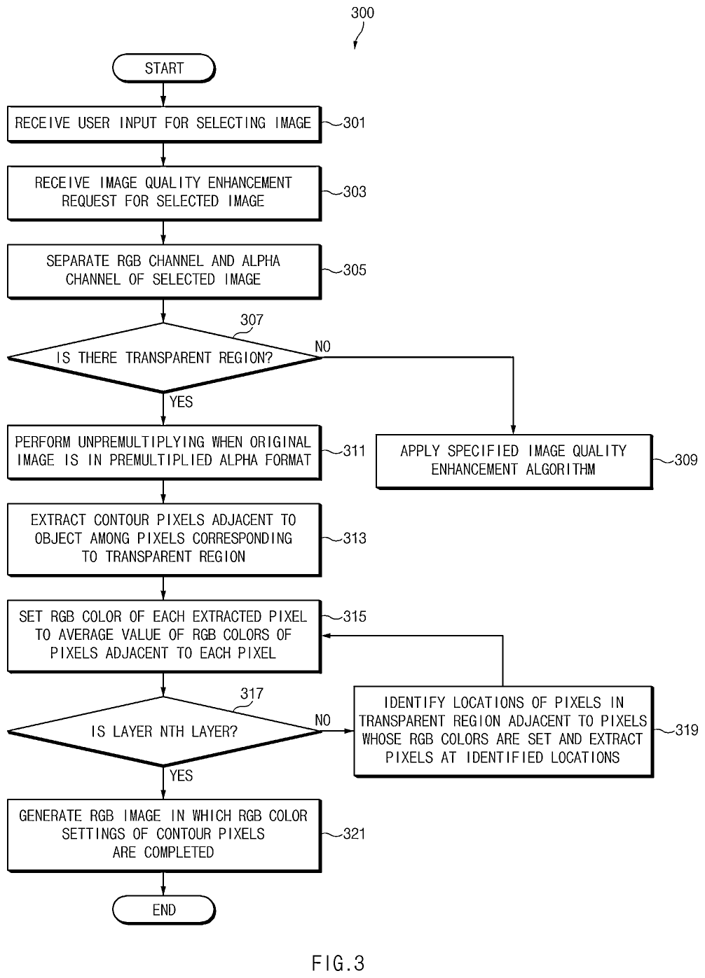

FIG. 3 is a flowchart of operations of an electronic device according to an embodiment of the disclosure. Operations of an electronic device to be described below may be performed by the electronic device 101 in FIG. 1 or a processor (e.g., the processor 130 in FIG. 1) of the electronic device 101. The operations to be described below are not limited to the order illustrated in FIG. 3. For example, the order of some operations may be changed, and some operations may be omitted or added.

Referring to FIG. 3, flowchart 300 illustrates that, in operation 301, an electronic device 101 may receive a user input for selecting an image. For example, the user input may be an input for selecting one of a plurality of images stored in the electronic device 101.

In operation 303, the electronic device 101 may receive an image quality enhancement request for the selected image. For example, the electronic device 101 may receive a user input related to image quality for the selected image. The user input related to image quality may include, for example, a user input for selecting an item for performing image quality enhancement from a menu item of a user interface provided together with the image.

In operation 305, the electronic device 101 may separate RGB channels and an alpha channel of the selected image. For example, the electronic device 101 may determine whether there is an alpha channel in the selected image. For example, when there is the alpha channel in the image, the electronic device 101 may separate the RGB channels and the alpha channel of the image. For example, when the alpha channel is not present in the image, the electronic device 101 may omit operation 305.

In operation 307, the electronic device 101 may determine whether there is a transparent region in the selected image. For example, the electronic device 101 may identify whether there is a pixel whose alpha channel value is not 0xFF (e.g., a pixel whose alpha channel value is 0x00). For example, when there is a pixel whose alpha channel value is 0x00, the electronic device 101 may determine that there is the transparent region in the selected image. For example, when there is no pixel whose alpha channel value is 0x00, the electronic device 101 may determine that there is no transparent region in the selected image.

For example, the electronic device 101 may determine whether there is the transparent region in the image based on transparency information included in a specified field (e.g., a field indicating a background color) of a header of an image file corresponding to the selected image.

The electronic device 101 may perform operation 309 when there is no transparent region in the selected image. In operation 309, the electronic device 101 may apply a specified image quality enhancement algorithm. The specified image quality enhancement algorithm may include, for example, an image quality enhancement algorithm for a normal image rather than a transparent background image. The specified image quality enhancement algorithm may be, for example, an image quality enhancement algorithm determined through image quality analysis performed by the electronic device 101 on an original image selected by a user.

The electronic device 101 may perform operation 311 when there is the transparent region in the selected image. In operation 311, the electronic device 101 may perform unpremultiplying when the original image is in the premultiplied alpha format. The premultiplied alpha format may be, for example, a format where the RGB values are multiplied by an alpha value normalized between 0 and 1. For example, the premultiplied alpha format may be an operation (or calculation) that divides the RGB value multiplied by the alpha value by the alpha value. For example, when the original image is in the non-premultiplied alpha format, the electronic device 101 may omit operation 311.

In operation 313, the electronic device 101 may extract contour pixels adjacent to an object among pixels corresponding to the transparent region. For example, the electronic device 101 may extract contour pixels adjacent to a pixel corresponding to the object among the pixels corresponding to the transparent region.

In operation 315, the electronic device 101 may set the RGB color of each extracted pixel (e.g., a contour pixel) to an average value of the RGB colors of pixels adjacent to each pixel. For example, the electronic device 101 may obtain an average value of RGB values of non-transparent pixels (e.g., pixels corresponding to the object) among pixels adjacent to each contour pixel. The electronic device 101 may set the RGB value of each contour pixel to the obtained average value. For example, pixels adjacent to the contour pixel may include a specified number of pixels (e.g., 4, 8, or 12) surrounding the contour pixels. For example, a set of contour pixels whose RGB colors are set by operation 315 may be referred to as a layer.

In operation 317, the electronic device 101 may check whether the layer of pixels whose the RGB colors are set in operation 315 is an Nth layer. N is a specified number of layers, and may be a natural number equal to or greater than 1. When the layer of pixels whose RGB colors are set in operation 315 is the Nth layer, the electronic device 101 may perform operation 321. When the layer of pixels whose RGB colors are set in operation 315 is not the Nth layer, the electronic device 101 may perform operation 319 and then repeat operation 315.

In operation 319, the electronic device 101 may identify locations of pixels in the transparent region adjacent to pixels (e.g., the contour pixels) whose RGB colors are set in operation 315. In operation 319, the electronic device 101 may extract pixels at the identified locations.

In operation 315 performed after performing operation 319, the electronic device 101 may set the RGB color of each pixel extracted in operation 319 to an average value of the RGB colors of pixels adjacent to each pixel. For example, the electronic device 101 may obtain an average value of RGB values (e.g., pixels corresponding to the object, or contour pixels included in a previous layer) of pixels that are not transparent among the pixels adjacent to each pixel. The electronic device 101 may set the RGB value of each pixel extracted in operation 319 to the obtained average value. For example, pixels whose RGB colors are set by operation 315 performed after operation 319 may be contour pixels constituting the next layer of the layer of contour pixels extracted in operation 315 performed before operation 319.

For example, the electronic device 101 may repeat operations 315, 317, and 319 until the number of layers reaches N. When the number of layers is determined to be N in operation 317, the electronic device 101 may perform operation 321.

In operation 321, the electronic device 101 may generate an RGB image in which RGB color settings of contour pixels are completed. For example, the electronic device 101 may generate an RGB image in which RGB color settings are completed for the contour pixels included in the N layers.

For example, for image quality analysis, the electronic device 101 may perform operations 313 to 319 only on a partial region of the selected image to obtain the RGB image. For example, in order to perform image quality enhancement after image quality analysis, the electronic device 101 may perform operations 313 to 319 on the entire region of the selected image to obtain the RGB image. For example, the electronic device 101 may identify the number of layers required in the image quality enhancement algorithm determined by image quality analysis, and designate the identified number of layers as N in operation 317.

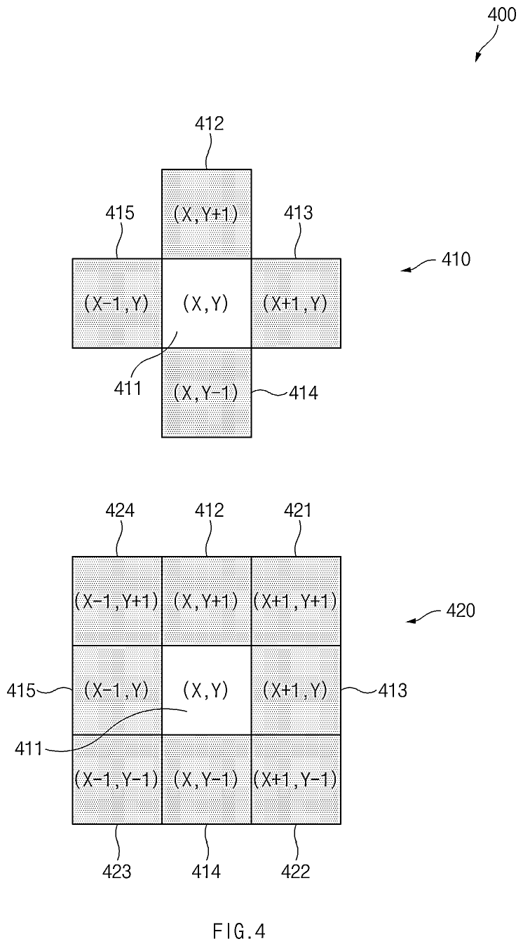

FIG. 4 is a view illustrating an example of adjacent pixels determined by an electronic device according to an embodiment of the disclosure. Operations of an electronic device to be described below may be performed by the electronic device 101 in FIG. 1 or a processor (e.g., the processor 130 in FIG. 1) of the electronic device 101. The operations of the electronic device 101 to be described below are related to operation 315 in FIG. 3.

Referring to FIG. 4, view 400 illustrates that an electronic device 101 may set color information about a contour pixel 411 based on color information about pixels adjacent to the contour pixel 411.

Referring to a first example 410 in FIG. 4, coordinates of the contour pixel 411 are (X, Y), and the number of adjacent pixels referred to in setting the color information about the contour pixels may be specified as 4. In this case, the electronic device 101 may set the color information about the contour pixel 411 based on color information about a first pixel 412 having coordinates (X, Y+1), a second pixel 413 having coordinates (X+1, Y), a third pixel 414 having coordinates (X, Y−1), and a fourth pixel 415 having coordinates (X−1, Y).

Referring to a second example 420 in FIG. 4, the coordinates of the contour pixel 411 are (X, Y), and the number of adjacent pixels referred to in setting the color information about the contour pixels may be specified as 8. In this case, the electronic device 101 may set the color information about the contour pixel 411 based on color information about a first pixel 412 having coordinates (X, Y+1), a second pixel 413 having coordinates (X+1, Y), a third pixel 414 having coordinates (X, Y−1), a fourth pixel 415 having coordinates (X−1, Y), a fifth pixel 421 having coordinates (X+1, Y+1), a sixth pixel 422 having coordinates (X+1, Y−1), a seventh pixel 423 having coordinates (X−1, Y−1), and an eighth pixel 424 having coordinates (X−1, Y+1).

For example, the electronic device 101 may set the color information about the contour pixel 411 based on color information about a non-transparent pixel among the pixels adjacent to the contour pixel 411. For example, the electronic device 101 may set the color information about the contour pixel 411 to an average value or a median value of color information about at least one non-transparent pixel, excluding color information (e.g., RGB value) about a transparent pixel among the first pixel 412, the second pixel 413, the third pixel 414, the fourth pixel 415, the fifth pixel 421, the sixth pixel 422, the seventh pixel 423, or the eighth pixel 424.

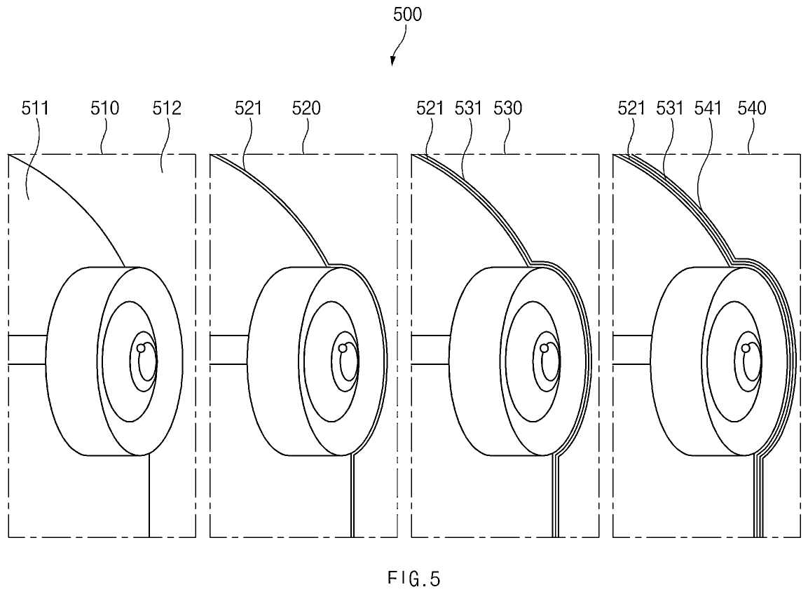

FIG. 5 is a view for describing an operation in which an electronic device according to an example adds a layer of contour pixels according to an embodiment of the disclosure. Operations of an electronic device to be described below may be performed by the electronic device 101 in FIG. 1 or a processor (e.g., the processor 130 in FIG. 1) of the electronic device 101. The operations of the electronic device 101 to be described below are related to operations 313 to 319 in FIG. 3.

Referring to FIG. 5, view 500 illustrates that a first image 510 may be an original image. For example, the first image 510 may be an original image of an image selected by a user input.

The electronic device 101 may extract contour pixels adjacent to an object 511 among pixels corresponding to a transparent region 512 of the first image 510. For example, the electronic device 101 may generate a first set of contour pixels including the extracted contour pixels. For example, the electronic device 101 may define the extracted contour pixels as the first set of contour pixels.

The electronic device 101 may set an RGB color of each extracted contour pixel to an average value of RGB colors of pixels adjacent to each contour pixel. For example, the electronic device 101 may set RGB values of the contour pixels of the first set to an average value of RGB values of non-transparent pixels adjacent to each contour pixel. The non-transparent pixels adjacent to the contour pixel may include, for example, pixels corresponding to an outer edge of the object. For example, the electronic device 101 may obtain a second image 520 in which RGB values of contour pixels of the first set are set.

A set of contour pixels whose RGB values are set may constitute a layer surrounding the object. The layer may only be used to apply a CNN-based image quality enhancement algorithm to the image. For example, an image in which a layer is added may be created and used only during image processing, and may not be provided to the user.

For example, the second image 520 may include one layer. For example, the second image 520 may be an image in which a first layer 521 including the contour pixels of the first set is added to the first image 510.

For example, when extracting the contour pixels of the first set, the electronic device 101 may identify locations of pixels of the transparent region 512 adjacent to the contour pixels of the first set. The electronic device 101 may extract pixels at the identified locations. For example, the electronic device 101 may generate a second set of contour pixels including the extracted pixels. For example, the electronic device 101 may define the extracted pixels as the second set of contour pixels.

For example, the electronic device 101 may set RGB values of the contour pixels of the second set to an average value of RGB values of non-transparent pixels (e.g., pixels corresponding to the object, or contour pixels included in a previous layer (e.g., the first layer 521)) among pixels adjacent to each contour pixel. For example, the electronic device 101 may obtain a third image 530 in which RGB values of contour pixels of the first set and the second set are set. For example, the third image 530 may include two layers. For example, the third image 530 may be an image in which the first layer 521 including the contour pixels of the first set and a second layer 531 including the contour pixels of the second set are added to the first image 510.

For example, when extracting the contour pixels of the second set, the electronic device 101 may identify locations of pixels of the transparent region 512 adjacent to the contour pixels of the second set. The electronic device 101 may extract pixels at the identified locations. For example, the electronic device 101 may generate a third set of contour pixels including the extracted pixels. For example, the electronic device 101 may define the extracted pixels as the third set of contour pixels.

For example, the electronic device 101 may set RGB values of the contour pixels of the third set to an average value of RGB values of non-transparent pixels (e.g., pixels corresponding to the object, or contour pixels included in a previous layer (e.g., the first layer 521)) among pixels adjacent to each contour pixel. For example, the electronic device 101 may obtain a fourth image 540 in which RGB values of the contour pixels of the first set, the second set, and the third set are set. For example, the fourth image 540 may include three layers. For example, the fourth image 540 may be an image in which the first layer 521 including the contour pixels of the first set, the second layer 531 including the contour pixels of the second set, and a third layer 541 including the contour pixels of the third set are added to the first image 510.

Although only images in which one to three layers are added are illustrated in FIG. 4, the disclosure is not limited thereto. For example, the electronic device 101 may obtain (or generate) an image in which a layer of a specified number (e.g., N) of contour pixels is added to the original image (e.g., the first image 510) according to the method described above. For example, when the specified number of layers is N, the electronic device 101 may generate N sets of contour pixels and set color information about pixels included in each set. For example, when setting color information about pixels included in an Nth set, for example, the most recently generated set, the electronic device 101 may omit an operation of identifying the locations of pixels in the transparent region 512 adjacent to pixels of the Nth set.

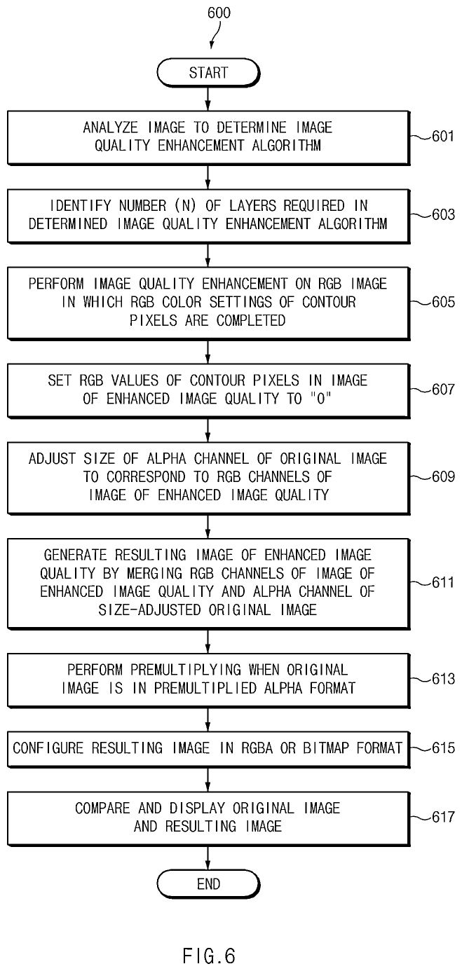

FIG. 6 is a flowchart of operations of an electronic device according to an embodiment of the disclosure. Operations of an electronic device to be described below may be performed by the electronic device 101 in FIG. 1 or a processor (e.g., the processor 130 in FIG. 1) of the electronic device 101. The operations to be described below are not limited to the order illustrated in FIG. 6. For example, the order of some operations may be changed, and some operations may be omitted or added.

Referring to FIG. 6, flowchart 600 illustrates that, in operation 601, an electronic device 101 may analyze an image to determine an image quality enhancement algorithm. For example, the electronic device 101 may perform image quality analysis on the RGB image generated in operation 321 in FIG. 3. For example, the image to be analyzed may be an RGB image generated by performing operations 313 to 321 on a partial region of the image selected in operation 301 in FIG. 3.

The electronic device 101 may perform image quality analysis on the image and determine an image quality enhancement algorithm corresponding to the image. For example, the electronic device 101 may determine at least one of the image quality enhancement algorithms stored in the electronic device 101 (or the memory of the electronic device 101 (e.g., the memory 120 in FIG. 1)) based on an image quality analysis result for the image. For example, image quality enhancement algorithms stored in the electronic device 101 may be CNN-based algorithms. For example, the image quality enhancement algorithms stored in the electronic device 101 may include a super resolution (or upscaling) algorithm, a deblur algorithm, a denoise algorithm, an exposure correction algorithm, a low-light enhancement algorithm, a compression artifact removal algorithm, and/or a haze removal algorithm.

In operation 603, the electronic device 101 may identify the number N of layers required in the image quality enhancement algorithm determined in operation 601. For example, the number of layers may be determined by the size of a kernel for performing a convolution operation of the image quality enhancement algorithm to be applied. For example, when a maximum size of the kernel is k, the number of layers may be (k−1)/2.

In operation 605, the electronic device 101 may perform image quality enhancement on an RGB image in which RGB color settings of contour pixels are completed. For example, the electronic device 101 may perform image quality enhancement on the RGB image generated in operation 321 in FIG. 3. For example, the image whose image quality is to be enhanced may be an RGB image generated by performing operations 313 to 321 on the entire region of the image selected in operation 301 in FIG. 3. For example, the electronic device 101 may generate an RGB image in which RGB color settings of contour pixels are completed by repeating operations 315 to 319 as many times as the number N of layers identified in operation 603. The electronic device 101 may perform image quality enhancement by applying the image quality enhancement algorithm determined in operation 601 to the generated RGB image. The electronic device 101 may obtain an image of enhanced image quality through operation 605.

In operation 607, the electronic device 101 may set the RGB values of the contour pixels in the image of enhanced image quality to “0.” For example, the electronic device 101 may reset the RGB values of the contour pixels set through operations 313 to 319 in FIG. 3 in the image of enhanced image quality to “0” through operation 607.

In operation 609, the electronic device 101 may adjust the size of the alpha channel of the original image to correspond to the RGB channels of the image of enhanced image quality. For example, the electronic device 101 may adjust the resolution of the alpha channel of the original image to be the same as the resolution output from the image quality enhancement algorithm. The resolution output from the image quality enhancement algorithm may be referred to as the resolution of the RGB channels of the image of enhanced image quality.

For example, operations 607 and 609 may be reversed in order. For example, the electronic device 101 may first perform operation 609 and then perform operation 607. For example, after adjusting the size of the alpha channel of the original image, the electronic device 101 may set the RGB values of a pixel whose value of the size-adjusted alpha channel in the image of enhanced image quality is “0” (completely transparent) to “0.”

In operation 611, the electronic device 101 may generate a resulting image of enhanced image quality by merging the RGB channels of the image of enhanced image quality and the alpha channel of the size-adjusted original image. For example, the electronic device 101 may merge the RGB channels of the image of enhanced image quality and the size-adjusted alpha channel of the original image to generate the resulting image converted into RGBA channels.

In operation 613, the electronic device 101 may perform premultiplying when the original image is in the premultiplied alpha format. For example, premultiplying may be an operation (or calculation) that multiplies an RGB value by an alpha value. Operation 613 may be an operation corresponding to operation 311 in FIG. 3. For example, when the original image is in the non-premultiplied alpha format, the electronic device 101 may omit operation 613.

In operation 615, the electronic device 101 may configure the resulting image in the RGBA or bitmap format. For example, the electronic device 101 may convert the resulting image into the RGBA or bitmap format that matches the alpha format of the original image through operations 613 and 615.

In operation 617, the electronic device 101 may compare and display the original image and the resulting image. For example, the electronic device 101 may display the original image and the resulting image on a display (e.g., the display 110 in FIG. 1). For example, the electronic device 101 may display the original image and the resulting image simultaneously or sequentially on the display 110. For example, the electronic device 101 may alternately display the original image and the resulting image on the display 110.

FIG. 7 is a view illustrating an example of image quality analysis information provided by an electronic device according to an embodiment of the disclosure. Operations of an electronic device to be described below may be performed by the electronic device 101 in FIG. 1 or a processor (e.g., the processor 130 in FIG. 1) of the electronic device 101.

Referring to FIG. 7, view 700 illustrates that, after performing operation 601 in FIG. 6, an electronic device 101 may display a screen 710 illustrated in FIG. 7. Referring to FIG. 7, the screen 710 may include an original image 711 and image quality analysis information 712. For example, the image quality analysis information 712 may correspond to an image quality analysis result for an image generated by performing image processing according to the process in FIG. 3 on the original image 711. For example, the image quality analysis information 712 may include information recommending an image quality enhancement algorithm determined through image quality analysis. In the example illustrated in FIG. 7, the image quality analysis information 712 provided by the electronic device 101 includes information recommending an algorithm for adjusting illuminance (or lighting).

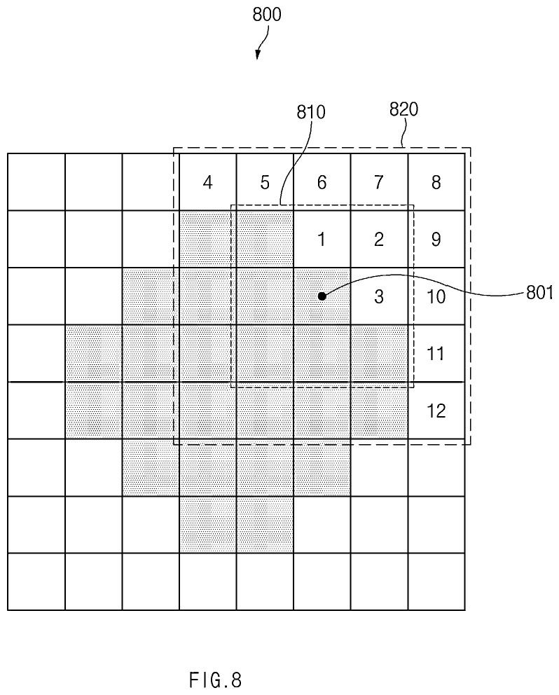

FIG. 8 is a view for describing a method for determining a number of layers of an electronic device according to an embodiment of the disclosure. Operations of an electronic device to be described below may be performed by the electronic device 101 in FIG. 1 or a processor (e.g., the processor 130 in FIG. 1) of the electronic device 101. The operations of the electronic device 101 to be described below are related to operation 603 in FIG. 6.

For example, the electronic device 101 may determine (or set) the number of layers according to the size of a kernel for performing a convolution operation of an image quality enhancement algorithm to be applied. For example, the electronic device 101 may determine the number of layers based on how many layers may be included in an external transparent region of a kernel applied around a pixel corresponding to an outer edge of an object.

Referring to FIG. 8, for example, view 800 illustrates that an electronic device 101 may determine the number of layers based on how many layers may be included in an external transparent region of a kernel applied around a first pixel 801 corresponding to the outer edge of an object.

For example, when using a first kernel 810 of 3×3 size in the image quality enhancement algorithm, pixels 1, 2, and 3 corresponding to the external transparent region may be included in the first kernel 810 of 3×3 size applied around the first pixel 801. The pixels 1, 2, and 3 may surround the first pixel 801 in one layer. For example, the first kernel 810 of 3×3 size applied around the first pixel 801 may include the external transparent region in one layer. For example, when a size k of the kernel of the image quality enhancement algorithm to be applied is 3, the electronic device 101 may determine the number of layers to be added for image quality enhancement as 1.

For example, when using a second kernel 820 of size 5×5 in the image quality enhancement algorithm, pixels 1, 2, 3, 4, 5, 6, 7, 8, 9, 10, 11, and 12 corresponding to the external transparent region may be included in the second kernel 820 of size 5×5 applied around the first pixel 801. The pixels 1, 2, 3, 4, 5, 6, 7, 8, 9, 10, 11, and 12 may surround the first pixel 801 in two layers. For example, the pixels 1, 2, and 3 may form one layer, the pixels 4, 5, 6, 7, 8, 9, 10, 11, and 12 may form another layer. For example, the kernel of 5×5 size applied around the first pixel 801 may include the external transparent region in two layers. For example, when the size k of the kernel of the image quality enhancement algorithm to be applied is 5, the electronic device 101 may determine the number of layers to be added for image quality enhancement as 2.

By generalizing the examples described above, when the maximum size of the kernel used in the image quality enhancement algorithm is k, the electronic device 101 may determine (or set) the number of layers as (k−1)/2.

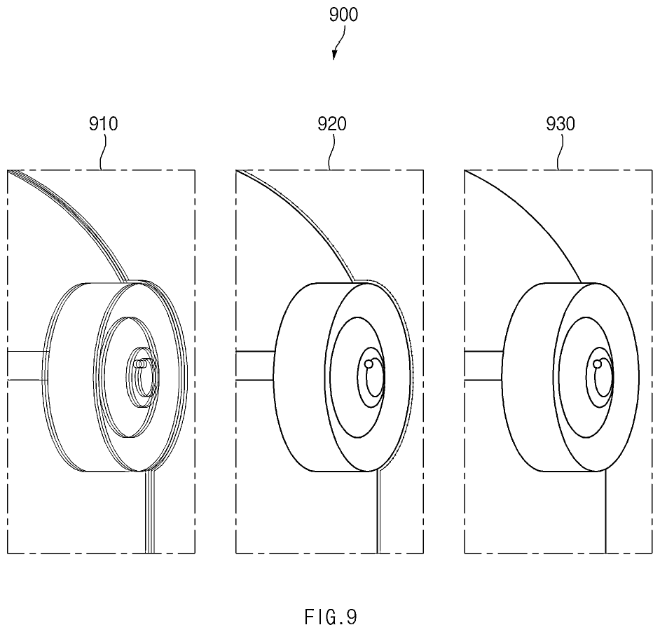

FIG. 9 is a view illustrating an image of enhanced image quality of an electronic device according to an example, in a manner of comparing with an original image and an image of enhanced image quality of an electronic device according to an embodiment of the disclosure.

Referring to FIG. 9, for example, view 900 illustrates that a first image 910 may be an original image before image quality enhancement. An electronic device according to the comparative example may provide a second image 920 after image quality enhancement. For example, the electronic device according to the comparative example may set RGB colors of pixels corresponding to a transparent region of the first image 910 to black. In this case, the second image 920 provided by the electronic device according to the comparative example may have a black artifact in a contour region of an object. For another example, the electronic device according to the comparative example may randomly set RGB colors of pixels corresponding to the transparent region of the first image 910. In this case, the second image 920 provided by the electronic device according to the comparative example may have various colors of artifacts in the contour region of the object.

An electronic device according to an example of the disclosure (e.g., the electronic device 101 in FIG. 1) may provide a third image 930 after image quality enhancement. The electronic device 101 according to an example of the disclosure may provide the third image 930 by performing the operations in FIGS. 3 and 6. For example, the electronic device 101 according to an example of the disclosure may extract contour pixels from pixels corresponding to a transparent region of the first image 910 and set RGB colors of the contour pixels based on RGB color information about non-transparent pixels among pixels adjacent to each pixel. In the third image 930 provided by the electronic device 101 according to the example of the disclosure, black artifacts or various colors of artifacts may appear reduced in the contour region of the object compared to the second image 920. The third image 930 provided by the electronic device 101 according to the example of the disclosure may be cleanly displayed without contour artifacts on the background of various colors.

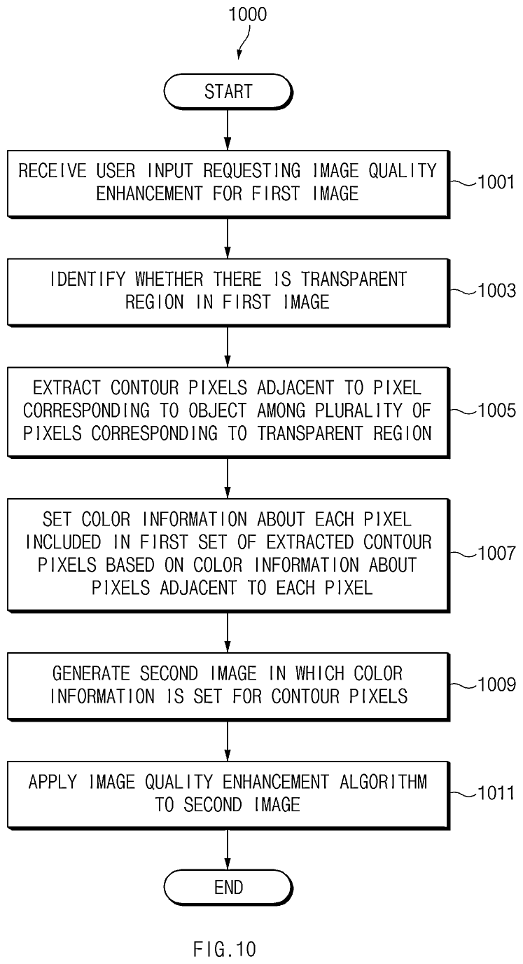

FIG. 10 is a flowchart of operations of an electronic device according to an embodiment of the disclosure. Operations of an electronic device to be described below may be performed by the electronic device 101 in FIG. 1 or a processor (e.g., the processor 130 in FIG. 1) of the electronic device 101. The operations to be described below are not limited to the disclosed order. For example, the order of some operations may be changed, and some operations may be omitted or added.

Referring to FIG. 10, flowchart 1000 illustrates that, in operation 1001, an electronic device 101 may receive a user input related to image quality for a first image. For example, the electronic device 101 may receive a user input for selecting the first image. For example, after receiving the user input for selecting the first image, the electronic device 101 may receive the user input related to image quality for the first image. The user input related to image quality may include, for example, a user input for selecting an item for performing image quality enhancement from a menu item of a provided user interface.

In operation 1003, the electronic device 101 may determine whether a transparent region exists in the first image. For example, the electronic device 101 may determine whether there is an alpha channel in the first image. The alpha channel is a channel that stores data other than the RGB values stored in RGB channels for each pixel, and may store transparency information, for example. For example, when there is the alpha channel in the first image, the electronic device 101 may separate the RGB channels and the alpha channel of the first image. For example, when at least some of pieces of the transparency information stored in the alpha channel of the first image indicate transparency, the electronic device 101 may identify (or determine) that the transparent region exists in the first image. For example, when there is a pixel whose alpha channel value is not 0xFF (e.g., a pixel whose alpha channel value is 0x00), the electronic device 101 may identify that the transparent region exists in the first image.

For example, the electronic device 101 may determine whether the transparent region exists in the first image based on transparency information included in a specified field (e.g., a field indicating a background color) of a header of an image file corresponding to the first image.

In operation 1005, the electronic device 101 may extract contour pixels adjacent to a pixel corresponding to an object among a plurality of transparent pixels corresponding to the transparent region. For example, when the transparent region exists in the first image, the electronic device 101 may extract contour pixels adjacent to the pixel corresponding to the object included in the first image among a plurality of transparent pixels corresponding to the transparent region. For example, the electronic device 101 may generate a first set of contour pixels including the extracted contour pixels. For example, the electronic device 101 may define the extracted contour pixels as the first set of contour pixels.

In operation 1007, the electronic device 101 may change color information about each pixel included in a first set of extracted contour pixels based on color information about pixels adjacent to each pixel. For example, the electronic device 101 may identify locations of pixels in the transparent region adjacent to pixels included in the first set and having changed color information. The electronic device 101 may extract pixels whose locations are identified to generate a second set of contour pixels. For example, the electronic device 101 may extract pixels whose locations are identified and define the extracted pixels as the second set of contour pixels. The electronic device 101 may set color information about each pixel included in the second set based on color information about pixels adjacent to each pixel.

For example, the electronic device 101 may generate a specified number of sets of contour pixels to set color information about pixels included in each set. For example, the electronic device 101 may generate a specified number of sets of contour pixels by repeating the process of generating the second set of contour pixels and setting color information about the contour pixels of the second set. The electronic device 101 may set color information about pixels included in each set. For example, when setting color information about a pixel included in the most recently generated set, the electronic device 101 may omit an operation of identifying the locations of pixels in the transparent region adjacent to the pixel included in the most recently generated set. For example, when the specified number of sets of contour pixels is N, the most recently generated set may be an Nth set.

For example, the electronic device 101 may set color information about a pixel (e.g., a contour pixel) included in the set of contour pixels based on color information about pixels adjacent to each pixel. For example, pixels adjacent to the contour pixel may contain a specified number of pixels (e.g., 4, 8, or 12) surrounding the contour pixel. For example, the electronic device 101 may obtain an average value or a median value of RGB values of at least one non-transparent pixel among a specified number of pixels surrounding the contour pixel. The electronic device 101 may set the color information about the contour pixel to the obtained average value or median value.

For example, as a first method, the electronic device 101 may set color information about all pixels corresponding to the transparent region using the method for setting color information to the contour pixels as described above.

For example, as a second method, the electronic device 101 may obtain an average value by averaging the color information about the pixels included in the set of contour pixels most recently generated by the method for setting color information to the contour pixels described above, and set color information about pixels corresponding to a remaining transparent region of the original image with the obtained average value.

For example, as a third method, the electronic device 101 may set the color information about all pixels corresponding to the transparent region to a value representing gray. Gray may be any value between the lightest white and the darkest black.

The amount of computation of the electronic device 101 may be reduced in the order of the first method, the second method, and the third method. For example, the electronic device 101 may select one of the first method, the second method, or the third method described above based on the resolution of the first image or the specifications of the electronic device 101. For example, when the resolution of the first image is equal to or higher than a threshold resolution, or when the electronic device 101 corresponds to a specified low-spec terminal, the electronic device 101 may set the color information about pixels corresponding to the transparent region using the second method or the third method rather than the first method.

In operation 1009, the electronic device 101 may generate a second image in which color information is changed for the contour pixels. For example, the electronic device 101 may analyze the second image (or analyze the image quality) to determine an image quality enhancement algorithm corresponding to the second image.

The image quality enhancement algorithm may be, for example, a CNN-based algorithm. For example, the electronic device 101 may select one of a plurality of CNN-based image quality enhancement algorithms stored in the electronic device 101 based on the analysis result for the second image. The plurality of CNN-based image quality enhancement algorithms may include a super resolution (or upscaling) algorithm, a deblur algorithm, a denoise algorithm, an exposure correction algorithm, a low-light enhancement algorithm, a compression artifact removal algorithm, and/or a haze removal algorithm.

For example, the electronic device 101 may display information recommending a determined image quality enhancement algorithm on a display (e.g., the display 110 in FIG. 1).

For example, the electronic device 101 may identify the number of sets of contour pixels required in the image quality enhancement algorithm. The electronic device 101 may generate the identified number of sets of contour pixels and set the color information about pixels included in each set.

For example, the electronic device 101 may set the color information about the contour pixels included in at least some of the sets to a value representing gray (e.g., 0.5 or 128) based on the resolution of the first image or the specifications of the electronic device 101. Gray may be any value between the lightest white and the darkest black. For example, when the resolution of the first image is equal to or higher than the threshold resolution, or when the electronic device 101 corresponds to a specified low-spec terminal, the electronic device 101 may set the color information about the contour pixels included in at least some of the sets to a value representing gray.

In operation 1011, the electronic device 101 may apply the image quality enhancement algorithm to the second image. For example, the electronic device 101 may obtain a third image of enhanced image quality from the second image. For example, the electronic device 101 may generate a fourth image by setting color information about pixels corresponding to the transparent region of the first image to “0” in the third image. The electronic device 101 may display the fourth image on the display 110 in a manner of comparing with the first image.

For example, the electronic device 101 may receive a user input requesting storage of the fourth image. The electronic device 101 may, in response to receiving the user input requesting storage of the fourth image, convert the fourth image into a specified file format and store the converted image.

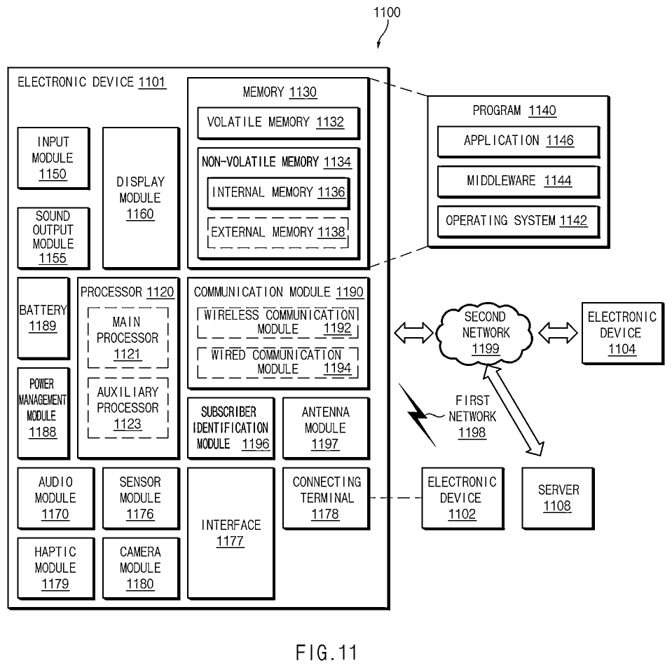

Below, electronic device 1101 in FIG. 11 may correspond to the electronic device 101 in FIG. 1.

FIG. 11 is a block diagram of an electronic device in a network environment according to an embodiment of the disclosure.

Referring to FIG. 11, an electronic device 1101 in a network environment 1100 may communicate with an electronic device 1102 via a first network 1198 (e.g., a short-range wireless communication network), or communicate with at least one of an electronic device 1104 or a server 1108 via a second network 1199 (e.g., a long-range wireless communication network). According to an example, the electronic device 1101 may communicate with the electronic device 1104 via the server 1108. According to an example, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In a certain example, at least one (e.g., the connecting terminal 1178) of the components may be omitted from the electronic device 1101, or one or more other components may be added in the electronic device 1101. In a certain example, some (e.g., the sensor module 1176, the camera module 1180, or the antenna module 1197) of the components may be integrated into one component (e.g., the display module 1160).

The processor 1120 may execute, for example, software (e.g., a program 1140) to control at least one other component (e.g., a hardware or software component) of the electronic device 1101 coupled to the processor 1120, and may perform various data processing or computation. According to an example, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an example, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 1101 includes the main processor 1121 and the auxiliary processor 1123, the auxiliary processor 1123 may be configured to use less power than the main processor 1121 or to be specialized for a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application), for example. According to an example, an auxiliary processor 1123 (e.g., an image signal processor or a communication processor) may be provided as part of another component (e.g., the camera module 1180 or the communication module 1190) functionally related to the auxiliary processor. According to an example, the auxiliary processor 1123 (e.g., a neural network processing device) may include a hardware structure specialized for processing an artificial intelligence model. The artificial intelligence model may be generated through machine learning. Such learning may be performed, for example, in the electronic device 1101 itself on which an artificial intelligence model is performed, or may be performed through a separate server (e.g., the server 1108). The learning algorithm may include, for example, supervised learning, unsupervised learning, semi-supervised learning, or reinforcement learning, but is not limited to the above-mentioned examples. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-networks, or a combination of two or more of the above networks, but is not limited to the above examples. The artificial intelligence model may additionally or alternatively include a software structure, in addition to the hardware structure.

The memory 1130 may store various data to be used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by a component (e.g., the processor 1120) of the electronic device 1101, from the outside (e.g., the user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an example, the receiver may be implemented separately from the speaker, or as part thereof.

The display module 1160 may visually provide information to the outside (e.g., the user) of the electronic device 1101. The display module 1160 may include, for example, a display, a hologram device, or a projector and control circuitry to control a corresponding one of the display, hologram device, and projector. According to an example, the display module 1160 may include a touch sensor adapted to detect a touch, or a pressure sensor adapted to measure the strength of force incurred by the touch.

The audio module 1170 may convert sound into an electrical signal and vice versa. According to an example, the audio module 1170 may acquire the sound via the input module 1150, or may output the sound via the sound output module 1155 or an external electronic device (e.g., the electronic device 1102) (e.g., a speaker or a headphone) directly or wirelessly connected to the electronic device 1101.

The sensor module 1176 may detect an operational state (e.g., power or temperature) of the electronic device 1101 or an external environmental state (e.g., a state of the user), and then generate an electrical signal or data value corresponding to the detected state. The sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be connected to an external electronic device (e.g., the electronic device 1102) directly or wirelessly. According to an example, the interface 1177 may include, for example, a high-definition multimedia interface (HDMI), a universal serial bus (USB) interface, a secure digital (SD) card interface, or an audio interface.

The connecting terminal 1178 may include a connector via which the electronic device 1101 may be physically connected to the external electronic device (e.g., the electronic device 1102). According to an example, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his/her tactile sensation or kinesthetic sensation. According to an example, the haptic module 1179 may include, for example, a motor, a piezoelectric element, or an electric stimulator.

The camera module 1180 may capture a still image or moving images. According to an example, the camera module 1180 may include one or more lenses, image sensors, image signal processors, or flashes.

The power management module 1188 may manage power supplied to the electronic device 1101. According to an example, the power management module 1188 may be implemented as at least part of, for example, a power management integrated circuit (PMIC).

The battery 1189 may supply power to at least one component of the electronic device 1101. According to an example, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and support a direct (e.g., wired) communication or a wireless communication. According to an example, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device 1104 via the first network 1198 (e.g., a short-range communication network, such as Bluetooth™, wireless-fidelity (Wi-Fi™) direct, or infrared data association (IrDA)) or the second network 1199 (e.g., a long-range communication network, such as a legacy cellular network, a fifth generation (5G) network, a next-generation communication network, the Internet, or a computer network (e.g., LAN or wide area network (WAN)). These various types of communication modules may be integrated into a single component (e.g., a single chip), or may be implemented as multi components (e.g., multi chips) separate from each other. The wireless communication module 1192 may identify or authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network after a fourth generation (4G) network and a next-generation communication technology, for example, a new radio (NR) access technology. NR access technology may support a high-speed transmission of high-capacity data (enhanced mobile broadband (eMBB)), minimization of terminal power and access to multiple terminals (massive machine type communications (mMTC)), or high reliability and low latency (ultra-reliable and low-latency communications (URLLC)). The wireless communication module 1192 may support a high frequency band (e.g., millimeter wave (mmWave) band) to achieve a high data rate, for example. The wireless communication module 1192 may support various techniques for securing performance in a high frequency band, for example, beamforming, massive multiple-input and multiple-output (MIMO), full dimensional MIMO (FD-MIMO), array antenna, analog beamforming, or large scale antenna. The wireless communication module 1192 may support various requirements defined in the electronic device 1101, an external electronic device (e.g., the electronic device 1104), or a network system (e.g., the second network 1199). According to an example, the wireless communication module 1192 may support a peak data rate (e.g., 20 gigabits per seconds (Gbps) or more) for achieving the eMBB, loss coverage (e.g., 164 decibels (dB) or less) for achieving the mMTC, or U-plane latency (e.g., 0.5 milliseconds (ms) or less each for downlink (DL) and uplink (UL), or 1 ms or less for the round trip) for achieving the URLLC.

The antenna module 1197 may transmit or receive a signal or power to or from the outside (e.g., an external electronic device). According to an example, the antenna module 1197 may include an antenna including a radiating element composed of a conductive material or a conductive pattern formed on a substrate (e.g., PCB). According to an example, the antenna module 1197 may include a plurality of antennas (e.g., an antenna array). In such a case, at least one antenna appropriate for a communication scheme used in the communication network, such as the first network 1198 or the second network 1199, may be selected from among the plurality of antennas, for example, by the communication module 1190. The signal or the power may be transmitted or received between the communication module 1190 and the external electronic device via the selected at least one antenna. According to a certain example, another component (e.g., a radio frequency integrated circuit (RFIC)) other than the radiating element may be additionally formed as a part of the antenna module 1197.

According to various examples, the antenna module 1197 may form an mmWave antenna module. According to an example, the mmWave antenna module may include a printed circuit board, an RFIC disposed on or adjacent to a first surface (e.g., a bottom surface) of the printed circuit board and capable of supporting a specified high frequency band (e.g., mmWave band), and a plurality of antennas (e.g., an array antenna) disposed on or adjacent to a second surface (e.g., top or side surface) of the printed circuit board and capable of transmitting or receiving signals of the designated high frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an example, commands or data may be transmitted or received between the electronic device 1101 and the external electronic device 1104 via the server 1108 coupled with the second network 1199. Electronic device 1102 or electronic device 1104 of the external electronic devices may be a device of a same type as, or a different type, from the electronic device 1101. According to an example, all or some of operations to be executed at the electronic device 1101 may be executed at one or more of the external electronic devices (e.g., electronic devices 1102 and 1104 and the server 1108). For example, when the electronic device 1101 should perform a function or a service automatically, or in response to a request from a user or another device, the electronic device 1101, instead of, or in addition to, executing the function or the service by itself, may request one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To this end, a cloud computing, distributed computing, mobile edge computing (MEC), or client-server computing technology may be used, for example. The electronic device 1101 may provide an ultra-low latency service using, for example, distributed computing or mobile edge computing. In another example, the external electronic device 1104 may include an Internet of things (IoT) device. The server 1108 may be an intelligent server using machine learning and/or neural networks. According to an example, the external electronic device 1104 or the server 1108 may be included in the second network 1199. The electronic device 1101 may be applied to an intelligent service (e.g., smart home, smart city, smart car, or health care) based on 5G communication technology and IoT-related technology.

As the transparent background images are generated and shared, there is a need for image quality analysis or enhancement of the transparent background image using the same experience and methods as for general images (e.g., the image rather than the transparent background).

Meanwhile, the convolution neural network (CNN)-based image quality enhancement algorithm is being used for image quality analysis and enhancement. Since a general image consists of three channels, RGB (red, green, blue), an input image of a deep-learning-based model (e.g., a CNN-based model) also mainly requires three channels. Therefore, in order to analyze or enhance a transparent background image consisting of four channels, only the remaining three channels (RGB channels) may be extracted, excluding the alpha channel containing transparency information, and used as inputs for the deep learning-based model.

In various applications, the RGB values corresponding to the transparent region in the image are set to (0, 0, 0), for example, black, and used as input information for CNN-based models. When convolution is applied to this input information, black artifacts (or noise) may appear at a contour region between the object and the background in the output image.

In addition, in various applications, RGB values corresponding to the transparent region in the image may be randomly set and used as input information for the CNN-based model. When convolution is applied to this input information, more colorful artifacts may appear in the contour region between the object and the background in the output image.

Embodiments of the disclosure may provide an electronic device, an operation method, and a storage medium for reducing contour artifacts when enhancing image quality for an image in which there is a transparent region.

Embodiments of the disclosure may provide an electronic device, an operation method, and a storage medium for reducing the possibility of misrecognition of image quality when analyzing the image quality of an image in which there is a transparent region.

An electronic device (e.g., electronic device 101 or electronic device 1101) according to an embodiment of the disclosure may include memory (e.g., memory 120 or memory 1130) and a processor (e.g., processor 130 or processor 1120). The memory may store instructions. The instructions, when executed, may cause the processor to receive a user input related to image quality of a first image. The instructions, when executed, may cause the processor to determine whether a transparent region is present in the first image. The instructions, when executed, may cause the processor to extract contour pixels adjacent to a pixel corresponding to an object included in the first image among a plurality of transparent pixels corresponding to the transparent region when the transparent region is present in the first image. The instructions, when executed, may cause the processor to set color information about each pixel included in a first set of the extracted contour pixels based on color information about pixels adjacent to each pixel. The instructions, when executed, may cause the processor to generate a second image in which the color information is changed for the contour pixels. The instructions, when executed, may cause the processor to apply an image quality enhancement algorithm to the second image.

According to an embodiment of the disclosure, the instructions, when executed, may cause the processor to: a) identify locations of pixels of the transparent region adjacent to pixels included in the first set and having changed color information. The instructions, when executed, may cause the processor to: b) extract the pixels whose locations are identified to generate a second set of contour pixels. The instructions, when executed, may cause the processor to: c) set color information about each pixel included in the second set based on color information about pixels adjacent to each pixel.

According to an embodiment of the disclosure, the instructions, when executed, may cause the processor to generate a specified number of sets of the contour pixels by repeating the a), b), and c) to set color information about pixels included in each set. The instructions, when executed, may cause the processor to omit an operation of identifying locations of pixels of the transparent region adjacent to a pixel included in a most recently generated set when setting color information about the pixel included in the most recently generated set.

According to an embodiment of the disclosure, the instructions, when executed, may cause the processor to obtain a third image of enhanced image quality from the second image. The instructions, when executed, may cause the processor to set color information about pixels corresponding to the transparent region of the first image in the third image to “0” to generate a fourth image.

According to an embodiment of the disclosure, the electronic device may include a display (e.g., display 110 or display module 1160). The instructions, when executed, may cause the processor to display the fourth image on the display in a manner of comparing with the first image.

According to an embodiment of the disclosure, the instructions, when executed, may cause the processor to convert and store the fourth image into a specified file format in response to receiving a user input requesting storage of the fourth image. The specified file format may include a file format that is the same as a file format of the first image.

According to an embodiment of the disclosure, the electronic device may include a display (e.g., display 110 or display module 1160). The instructions, when executed, may cause the processor to analyze the second image to determine the image quality enhancement algorithm corresponding to the second image. The instructions, when executed, may cause the processor to display information recommending the determined image quality enhancement algorithm on the display.

According to an embodiment of the disclosure, the instructions, when executed, may cause the processor to identify a number of sets of the contour pixels required in the image quality enhancement algorithm. The instructions, when executed, may cause the processor to generate the identified number of sets of the contour pixels to set color information about pixels included in each set. The instructions, when executed, may cause the processor to set color information about the contour pixels included in at least some of the sets to a value representing gray based on a resolution of the first image or specifications of the electronic device. Accordingly, the amount of computation of the electronic device may be reduced and the computation speed may be increased.

According to an embodiment of the disclosure, the instructions, when executed, may cause the processor to set color information about all pixels corresponding to the transparent region using a color information setting method for the contour pixels, set color information about pixels corresponding to a remaining transparent region of the first image to an average value of color information about pixels included in the set of contour pixels generated most recently, or set color information about all pixels corresponding to the transparent region to a value representing gray. Accordingly, the electronic device may select an appropriate method depending on the amount of computation the electronic device may process (or smoothly), and prevent the load from becoming excessive.

According to an embodiment of the disclosure, pixels adjacent to each pixel may include a specified number of pixels surrounding each pixel.

A method for operating an electronic device (e.g., electronic device 101 or electronic device 1101) according to an embodiment of the disclosure may include receiving a user input related to image quality for a first image. The method may include determining whether there is a transparent region in the first image. The method may include extracting contour pixels adjacent to a pixel corresponding to an object included in the first image among a plurality of transparent pixels corresponding to the transparent region when the transparent region is present in the first image. The method may include setting color information about each pixel included in a first set of the extracted contour pixels based on color information about pixels adjacent to each pixel. The method may include generating a second image in which color information is changed for the contour pixels. The method may include applying an image quality enhancement algorithm to the second image.

According to an embodiment of the disclosure, the method may include a) identifying locations of pixels of the transparent region adjacent to pixels included in the first set and having changed color information. The method may include b) extracting the pixels whose locations are identified to generate a second set of contour pixels. The method may include c) setting color information about each pixel included in the second set based on color information about pixels adjacent to each pixel.

According to an embodiment of the disclosure, in the method, a specified number of sets of the contour pixels may be generated by repeating the a), b), and c) to set color information about pixels included in each set. In the method, an operation of identifying locations of pixels of the transparent region adjacent to a pixel included in a most recently generated set may be omitted when setting color information about the pixel included in the most recently generated set.

According to an embodiment of the disclosure, the method may include obtaining a third image of enhanced image quality from the second image. The method may include setting color information about pixels corresponding to the transparent region of the first image in the third image to “0” to generate a fourth image.

According to an embodiment of the disclosure, the method may include displaying the fourth image on a display (e.g., display 110 or display module 1160) in a manner of comparing with the first image.

According to an embodiment of the disclosure, the method may include converting and storing the fourth image into a specified file format in response to receiving a user input requesting storage of the fourth image. The specified file format may include a file format that is the same as a file format of the first image.

According to an embodiment of the disclosure, the method may include analyzing the second image to determine the image quality enhancement algorithm corresponding to the second image. The method may include displaying information recommending the determined image quality enhancement algorithm on a display (e.g., display 110 or display module 1160).

According to an embodiment of the disclosure, the method may include identifying a number of sets of the contour pixels required in the image quality enhancement algorithm. The method may include generating as many sets of the contour pixels as the identified number to set color information about pixels included in each set. The method may include setting color information about the contour pixels included in at least some of the sets to a value representing gray based on a resolution of the first image or specifications of the electronic device.

According to an embodiment of the disclosure, the method may set color information about all pixels corresponding to the transparent region using a method for setting color information for the contour pixels. Alternatively, the method may include setting color information about pixels corresponding to a remaining transparent region of the first image to an average value of color information about pixels included in the set of contour pixels generated most recently. Alternatively, the method may include setting color information about all pixels corresponding to the transparent region to a value representing gray.

According to an embodiment of the disclosure, pixels adjacent to each pixel may include a specified number of pixels surrounding each pixel.

A non-transitory computer-readable storage medium according to an embodiment of the disclosure may store a program for performing a method for operating an electronic device. The method for operating the electronic device may include receiving user input related to image quality of a first image. The method may include determining whether there is a transparent region in the first image. The method may include extracting contour pixels adjacent to a pixel corresponding to an object included in the first image among a plurality of transparent pixels corresponding to the transparent region when the transparent region is present in the first image. The method may include setting color information about each pixel included in a first set of the extracted contour pixels based on color information about pixels adjacent to each pixel. The method may include generating a second image in which color information is changed for the contour pixels. The method may include applying an image quality enhancement algorithm to the second image.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. The term “non-transitory” simply denotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing one or more computer programs; and
one or more processors communicatively coupled to the memory,
wherein the one or more computer programs include computer-executable instructions that, when executed by the one or more processors individually or collectively, cause the electronic device to:
receive a user input related to image quality of a first image,
determine whether a transparent region exists in the first image,
determine a plurality of transparent pixels corresponding to the transparent region when the transparent region exists in the first image,
extract contour pixels adjacent to a pixel corresponding to an object included in the first image among the plurality of transparent pixels,
change color information about each pixel included in a first set of contour pixels among the extracted contour pixels based on color information about pixels adjacent to each pixel,
generate a second image including the contour pixels of the changed color information, and
apply an image quality enhancement algorithm to the second image.

2. The electronic device of claim 1, wherein the one or more computer programs further include computer-executable instructions that, when executed by the one or more processors individually or collectively, cause the electronic device to:
perform a function a) of identifying locations of pixels of the transparent region adjacent to pixels included in the first set and having the changed color information,
perform a function b) of extracting the pixels whose locations are identified to generate a second set of contour pixels, and
perform a function c) of setting color information about each pixel included in the second set based on the color information about pixels adjacent to each pixel.

3. The electronic device of claim 2, wherein the one or more computer programs further include computer-executable instructions that, when executed by the one or more processors individually or collectively, cause the electronic device to:
generate a specified number of sets of the contour pixels by repeating the function a), the function b), and the function c) to set color information about pixels included in each set, and
omit an operation of identifying locations of pixels of the transparent region adjacent to a pixel included in a most recently generated set when setting color information about the pixel included in the most recently generated set.

4. The electronic device of claim 1, wherein the one or more computer programs further include computer-executable instructions that, when executed by the one or more processors individually or collectively, cause the electronic device to:
obtain a third image of enhanced image quality from the second image, and
set color information about pixels corresponding to the transparent region of the first image in the third image to “0” to generate a fourth image.

5. The electronic device of claim 4, further comprising:
a display,
wherein the one or more computer programs further include computer-executable instructions that, when executed by the one or more processors individually or collectively, cause the electronic device to:
display the fourth image on the display in a manner of comparing with the first image.

6. The electronic device of claim 5,
wherein the one or more computer programs further include computer-executable instructions that, when executed by the one or more processors individually or collectively, cause the electronic device to:
convert and store the fourth image into a specified file format in response to receiving a user input requesting storage of the fourth image, and
wherein the specified file format includes a file format that is a same file format as a file format of the first image.

7. The electronic device of claim 1, further comprising:
a display,
wherein the one or more computer programs further include computer-executable instructions that, when executed by the one or more processors individually or collectively, cause the electronic device to:
analyze the second image to determine the image quality enhancement algorithm corresponding to the second image, and
display information recommending the image quality enhancement algorithm on the display.

8. The electronic device of claim 1, wherein the one or more computer programs further include computer-executable instructions that, when executed by the one or more processors individually or collectively, cause the electronic device to:
identify a number of sets of the contour pixels required in the image quality enhancement algorithm, and
generate the identified number of sets of the contour pixels to set color information about pixels included in each set, color information about the contour pixels included in at least some of the sets being set to a value representing gray based on a resolution of the first image or specifications of the electronic device.

9. The electronic device of claim 1, wherein the one or more computer programs further include computer-executable instructions that, when executed by the one or more processors individually or collectively, cause the electronic device to:
set color information about all pixels corresponding to the transparent region using a color information setting method for the contour pixels,
set color information about pixels corresponding to a remaining transparent region of the first image to an average value of color information about pixels included in a recent set of contour pixels generated most recently, or
set color information about all pixels corresponding to the transparent region to a value representing gray.

10. The electronic device of claim 1, wherein the pixels adjacent to each pixel include a specified number of pixels surrounding each pixel.

11. A method performed by an electronic device, the method comprising:
receiving, by the electronic device, a user input related to image quality of a first image;
determining, by the electronic device, whether a transparent region exists in the first image;
determining, by the electronic device, a plurality of transparent pixels corresponding to the transparent region based on determining that the transparent region exists in the first image;
extracting, by the electronic device, contour pixels adjacent to a pixel corresponding to an object included in the first image among the plurality of transparent pixels;
changing, by the electronic device, color information about each pixel included in a first set of contour pixels among the extracted contour pixels based on color information about pixels adjacent to each pixel;
generating, by the electronic device, a second image including the contour pixels of the changed color information; and
applying, by the electronic device, an image quality enhancement algorithm to the second image.

12. The method of claim 11, further comprising:
performing, by the electronic device, a function a) of identifying locations of pixels of the transparent region adjacent to pixels included in the first set and having the changed color information;
performing, by the electronic device, a function b) of extracting the pixels whose locations are identified to generate a second set of contour pixels; and
performing, by the electronic device, a function c) of setting color information about each pixel included in the second set based on the color information about pixels adjacent to each pixel.

13. The method of claim 12,
wherein a specified number of sets of the contour pixels is generated by repeating the function a), the function b), and the function c) to set color information about pixels included in each set, and
wherein an operation of identifying locations of pixels of the transparent region adjacent to a pixel included in a most recently generated set is omitted based on setting color information about the pixel included in the most recently generated set.

14. The method of claim 11, further comprising:
obtaining, by the electronic device, a third image of enhanced image quality from the second image; and
setting, by the electronic device, color information about pixels corresponding to the transparent region of the first image in the third image to “0” to generate a fourth image.

15. The method of claim 14, further comprising:
displaying, by the electronic device, the fourth image on a display in a manner of comparing with the first image.

16. The method of claim 15, further comprising:
converting, by the electronic device, and storing, by the electronic device, the fourth image into a specified file format in response to receiving a user input requesting storage of the fourth image,
wherein the specified file format includes a file format that is a same file format as a file format of the first image.

17. The method of claim 11, further comprising:
analyzing, by the electronic device, the second image to determine the image quality enhancement algorithm corresponding to the second image; and
displaying, by the electronic device, information recommending the image quality enhancement algorithm on a display of the electronic device.

18. The method of claim 11, further comprising:
identifying, by the electronic device, a number of sets of the contour pixels required in the image quality enhancement algorithm; and
generating, by the electronic device, the identified number of sets of the contour pixels to set color information about pixels included in each set, color information about the contour pixels included in at least some of the sets being set to a value representing gray based on a resolution of the first image or specifications of the electronic device.

19. One or more non-transitory computer-readable storage media storing one or more computer programs including computer-executable instructions that, when executed by one or more processors of an electronic device individually or collectively, cause the electronic device to perform operations, the operations comprising:
receiving, by the electronic device, a user input related to image quality of a first image;
determining, by the electronic device, whether a transparent region exists in the first image;
determining, by the electronic device, a plurality of transparent pixels corresponding to the transparent region based on determining that the transparent region exists in the first image;
extracting, by the electronic device, contour pixels adjacent to a pixel corresponding to an object included in the first image among the plurality of transparent pixels;
changing, by the electronic device, color information about each pixel included in a first set of contour pixels among the extracted contour pixels based on color information about pixels adjacent to each pixel;
generating, by the electronic device, a second image including the contour pixels of the changed color information; and
applying, by the electronic device, an image quality enhancement algorithm to the second image.

20. The one or more non-transitory computer-readable storage media of claim 19, the operations further comprising:
performing, by the electronic device, a function a) of identifying locations of pixels of the transparent region adjacent to pixels included in the first set and having the changed color information;
performing, by the electronic device, a function b) of extracting the pixels whose locations are identified to generate a second set of contour pixels; and
performing, by the electronic device, a function c) of setting color information about each pixel included in the second set based on the color information about pixels adjacent to each pixel,
wherein a specified number of sets of the contour pixels is generated by repeating the function a), the function b), and the function c) to set color information about pixels included in each set, and
wherein an operation of identifying locations of pixels of the transparent region adjacent to a pixel included in a most recently generated set is omitted based on setting color information about the pixel included in the most recently generated set.
